(19) United States
(12) Patent Application Publication
(10) Pub. No.: US 2024/0284233 A1
(43) Pub. Date: Aug. 22, 2024

(54) ADAPTATION OF SYNCHRONIZATION SIGNAL BLOCK PERIODICITY

(71) Applicant: Telefonaktiebolaget LM Ericsson (publ), Stockholm (SE)

(72) Inventors: Sina MALEKI, Malmö (SE); Ali NADER, Malmö (SE); Ilmiawan SHUBHI, Malmö (SE); Andres REIAL, Höllviken (SE); Ryan PADERNA, Yokohama Kanagawa (JP)

(21) Appl. No.: 18/685,003

(22) PCT Filed: Aug. 26, 2022
(86) PCT No.: PCT/EP2022/073843

§ 371 Date: Feb. 20, 2024

Related U.S. Application Data
(60) Provisional application No. 63/237,853, filed on Aug. 27, 2021.

(51) Int. Cl. H04W 24/10

(52) U.S. Cl. CPC H04W 24/10

(57) ABSTRACT

A method, system and apparatus are disclosed. A network node configured to communicate at least with a wireless device (WD). The network node incudes processing circuitry configured to determine a Synchronization Signal Block (SSB) configuration including a first set of SSBs to be transmitted periodically at a first set periodicity and a second set of SSBs to be transmitted periodically at a second set periodicity. Each SSB of the second set of SSBs is configurable to be transmitted periodically at an SSB periodicity. A radio interface in communication with the processing circuitry is configured to transmit the SSB configuration to the WD. The transmitted SSB configuration triggers the WD to perform at least one measurement associated with at least one SSB of any one of the first set of SSBs and the second set of SSBs.

### TECHNICAL FIELD

The present disclosure relates to wireless communications, and in particular, to adaptation of Synchronization Signal Block (SSB) periodicity.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes, such as base stations, and mobile wireless devices (WD), as well as communication between network nodes and between WDs.

### Energy Consumption

Energy consumption, such as energy transformed in order to support communication between network nodes and WDs, may be different for different wireless communication systems. For example, energy consumption associated with operation of NR wireless communication systems, e.g., a network node supporting NR, is generally greater than energy consumption associated with operation of LTE wireless communication systems, e.g., a network node supporting LTE. In some cases, the difference in energy consumption is due to complexity of hardware used in NR wireless communication system, e.g., NR hardware supports greater bandwidth and/or uses more antennas than typical LTE hardware. The greater energy consumption NR systems generally evident when a network node operates at higher frequencies.

To save energy, a network node or a component of a network node, e.g., a network node module or network node hardware, may be turned on/off for a period of time, e.g., during a period of inactivity. The period of time can be used as a sleep opportunity, i.e., an opportunity to turn off the network node or a component of the network node. However, turning on/off modules during times of inactivity becomes difficult and requires time, such as time for activation and deactivation. For example, to operate in frequency ranges supported in NR, e.g., in Frequency Range 2 (FR2), an NR network node such as an gNB may be configured with up to 64 beams. The 64 beams may be used to transmit up to 64 Synchronization Signal Blocks (SSBs), which require 64 ports. Such SSBs are typically expected to be transmitted every 20 ms in SSB Measurement Timing Configuration (SMTC) windows of 5 ms. The time where SSBs are not being transmitted may be used as a sleep opportunity. However, compared to transmissions where SSBs are transmitted at a rate slower than every 20 ms, transmitting SSBs every 20 ms decreases sleep opportunity, e.g., for turning network node modules off Additionally, even when there are no WDs in a connected mode (i.e., Radio Resource Control (RRC) connected mode) in a cell served by the network node, e.g., a gNB, the network node listens/monitors on Physical Random Access Channel (PRACH) for potential random access attempts from WDs. Listening on PRACH also requires energy consumption, thereby affecting sleep opportunities.

### SSB Configuration

A network node may be configured with multiple SSBs in an SSB Measurement Timing Configuration (SMTC) window. For example, a network node supporting NR, e.g., a gNB, may be configured with up to 64 SSBs in each of a primary SMTC (SMTC1) window and a secondary SMTC (SMTC2) window. The configured SSBs have the same periodicities, which are configured by SMTC periodicity.

### Reference Signal Measurement Timing Configuration

In NR, a network node, e.g., a gNB, can provide information to the WDs about how many and/or which SSBs are active (i.e., present) within a serving cell and neighboring cells. The network node can further provide information about a rate at which the SSBs are provided on a cell. For a serving cell, an ssb-PositionsInBurst parameter indicates which of the SSBs are active, and an ssb-PeriodicityServingCell parameter specifies a rate or periodicity of SSBs.

With respect to neighboring cells, a network node, e.g., an gNB, can indicate the neighboring active (i.e., present) SSBs via an ssb-ToMeasure parameter and the associated rate/periodicity via an SMTC, which defines a time window during which a WD measures SSBs corresponding to the neighboring cells.

A WD may be configured with SSB presence and timing/rate information described above when the WD is in different states. When the WD is in a state such as RRC_IDLE/INACTIVE, the WD may be configured via broadcast system information or in RRC_Connected via dedicated messages. When the WD is in a state such as IDLE/INACTIVE, the ssb-PositionsInBurst and ssb-PeriodicityServing parameters for a serving cell may be configured via System Information Block (SIB), e.g., a type 1 SIB (SIB1), or via dedicated RRC configuration. For neighboring cells, there is a regular/primary SMTC configuration (in SIB2/SIB4). Additionally, the WD may be configured with a secondary SMTC2-LP (Larger Period) configuration relevant for specified neighboring cells with larger SSB periodicity, e.g., larger than an SSB periodicity associated with primary cell. For neighboring cell measurements, when the WD is in a connected mode, the WD may be configured with the primary SMTC (i.e., SMTC1) configuration and configured with a secondary SMTC (i.e., SMTC2) configuration. The secondary SMTC configuration is relevant to specified neighboring cells that have a shorter SSB periodicity than the SSB periodicity of primary SMTC. Further, another SMTC, i.e., an SMTC3, is used for configuration of Integrated Access and Backhaul (IAB) nodes.

The WD may be configured to set up SMTCs in accordance with a received periodicityAndOffset parameter in the primary SMTC, i.e., the SMTC1, configuration. For example, the received periodicityAndOffset parameter may provide a periodicity and offset value. The first subframe of each SMTC occasion occurs at a System Number (SFN) and subframe (SF) of an NR Special Cell (SpCell) meeting the following condition:

SFN mod T=(FLOOR(Offset/10));

if the Periodicity is larger than SF5:
subframe=Offset mod 10;

else:
subframe=Offset or (Offset+5);
with T=CEIL(Periodicity/10).

If SMTC2 is present: for cells indicated in a pci-List parameter in SMTC2 in the same object, i.e., MeasObjectNR, the WD sets up an additional SMTC, e.g., Synchronization Signal (SS)/Physical Broadcast Channel (PBCH) block measurement timing configuration, in accordance with the received periodicity parameter in the SMTC2 configuration. The offset, e.g., derived from parameter periodicityAndOffset, and duration parameter from the SMTC1 configuration are used. The first subframe of each SMTC occasion occurs at an SFN and subframe of the NR SpCell meeting the above condition.

If smtc2-LP is present: for cells indicated in the pci-List parameter in smtc2-LP in the same frequency (e.g., for intra frequency cell reselection) or different frequency (e.g., for inter frequency cell reselection), the WD may set up an additional SS/PBCH block measurement timing configuration (SMTC) in accordance with the received periodicity parameter in the smtc2-LP configuration. The WD may use the offset (e.g., derived from parameter periodicityAndOffset) and duration parameter from the SMTC configuration for the frequency. The first subframe of each SMTC occasion occurs at an SFN and subframe of the NR SpCell or serving cell (e.g., for cell reselection) meeting the above condition.

If smtc3list is present: for cells indicated in the pci-List parameter in each SSB-MTC3 element (i.e., SMTC3 element) such as from a list in the same MeasObjectNR, the Integrated Access Backhaul Mobile Terminal (IAB-MT) may set up an additional SS block measurement timing configuration, i.e., SMTC, in accordance with the received periodicityAndOffset parameter in each SSB-MTC3 configuration and uses the duration and ssb-ToMeasure parameters from each SSB-MTC3 configuration. Setting up an additional SMTC in accordance with the received periodicityAndOffset parameter may include using a condition same as smtc1 to identify the SFN and the subframe for SMTC occasion.

On an indicated ssbFrequency, the WD does not consider SS/PBCH block, i.e., SSB, transmission in subframes outside the SMTC occasion for RRM measurements based on SS/PBCH blocks and for Radio Resource Management (RRM) measurements based on a Channel State Information Reference Signal (CSI-RS), except for SFN and Frame Timing Difference (SFTD) measurement, e.g., as described in 3GPP Technical Specification (TS) 38.133, Version 17.2.0 (2021-06) in subclause 9.3.8.

In other words, the increasing the number of SSB transmissions in NR, thereby generating a larger number of associated PRACH monitoring intervals particularly at higher frequencies, can increase energy consumption associated with operating network equipment, such as network nodes. Also contributing to energy consumption is that, although SSBs can be configured with up to 160 ms periodicity, WDs are typically configured to expect at least one set of SSBs to be transmitted every 20 ms.

### SUMMARY

Some embodiments advantageously provide methods, systems, and apparatuses for adaptation of SSB periodicity. In some other embodiments, methods and processes are described, in which a network node may configure SSBs with individual/respective periodicities. The network node may configure multiple sets of SSBs, where the first set provides cell coverage for legacy WDs and/or initial access at a first periodicity, e.g., 20 ms. Additional SSB sets may have other periodicities, e.g., shorter/longer periods. The availability of the SSBs may be configured via additional broadcast signaling in System Information (SI) and/or via dedicated Radio Resource Control (RRC) signaling, e.g., via a predetermined signaling. The additional SSB sets may be utilized for a predetermined process, e.g., for higher-resolution beam establishment or neighbor-cell RRM measurements. SSBs may be transmitted covering an entire cell area and/or covering cell regions/with expected UE presence or measurement relevance.

By adapting at least SSB periodicity as described in the present disclosure, the network node can configure underutilized SSBs with longer periodicities than the periodicity of SSBs that are highly utilized and/or coverage SSBs. Further, the network node may turn off and/or control at least a power parameter associated with at least one network node component, e.g., hardware/modules such as antenna ports, during periods of time, e.g., inactivity periods. By turning off and/or controlling at least a power parameter, the network node can save energy/power consumption.

According to one aspect, a network node configured to communicate at least with a wireless device (WD) is described. The network node includes processing circuitry configured to determine a Synchronization Signal Block (SSB) configuration including a first set of SSBs to be transmitted periodically at a first set periodicity and a second set of SSBs to be transmitted periodically at a second set periodicity. Each SSB of the second set of SSBs is configurable to be transmitted periodically at an SSB periodicity. A radio interface in communication with the processing circuitry is configured to transmit the SSB configuration to the WD, where the transmitted SSB configuration triggers the WD to perform at least one measurement associated with at least one SSB of any one of the first set of SSBs and the second set of SSBs.

In some embodiments, determining the SSB configuration includes determining a first SSB time window that is configured to occur periodically at a first time window periodicity and is a first time interval including at least one SSB of the first set of SSBs; and determining a second SSB time window that is configured to occur periodically at a second time window periodicity and is a second time interval including at least one SSB of the second set of SSBs. The first time window periodicity is the first set periodicity, and the second time window periodicity is the second set periodicity.

In some other embodiments, the second time interval of the second SSB time window further includes at least one SSB of the first set of SSBs.

In one embodiment, any one of the first SSB time window and the second SSB time window is determined based at least in part on any one of: an SSB periodicity parameter defining a periodicity of at least one SSB when the at least one SSB is associated with a first cell; and an SSB Measurement Timing Configuration, SMTC, defining a time window for the WD to measure the at least one SSB when the at least one SSB is associated with a second cell.

In an embodiment, the first cell is a serving cell, and the second cell is a neighboring cell.

In another embodiment, the second time window periodicity is configured one of as an absolute time value; based on the first time window periodicity; and as an offset time value defining a time interval between the first SSB time window and the second SSB time window.

In some embodiments, the first SSB time window corresponds to one WD, and the second SSB time window corresponds to another WD.

In some other embodiments, any one of each SSB of the first set of SSBs and each SSB of the second set of SSBs is transmitted using any one of one antenna port and one corresponding module, and the processing circuitry is further configured to determine that the WD will not use any one of at least one SSB of the first set of SSBs and at least one SSB of the second set of SSBs; and cause any one of the one antenna port and the one corresponding module usable to transmit the corresponding SSB to turn off.

In an embodiment, the SSB configuration includes a plurality of SSB spatial configurations defining a plurality of wireless signal beams. At least one SSB of the first set of SSBs corresponds to at least a first wireless signal beam of the plurality of wireless signal beams. At least one SSB of the second set of SSBs corresponds to at least a second wireless signal beam of the plurality of wireless signal beams. The at least first wireless signal beam has a first beam width, and the at least second wireless signal beam has a second beam width.

In another embodiment, the processing circuitry is further configured to determine a fraction of a coverage area; determine that one of the WD is located within the fraction of the coverage area and the WD is moving in a direction that indicates neighbor-cell measurements are expected; select the at least one SSB of the second set of SSBs corresponding to the at least second wireless signal beam. The second beam width is narrower than the first beam width and narrower than a width associated with the determined fraction of the coverage area. The second wireless signal beam is usable to transmit signaling to the WD while one of the WD is located within the fraction of the coverage area and the WD is moving in the direction that indicates neighbor-cell measurements are expected. The radio interface is further configured to transmit the signaling to the WD.

In some embodiments, the at least first wireless signal beam has a first angle of departure, and the at least second wireless signal beam has a second angle of departure.

In some other embodiments, the SSB periodicity of at least one SSB of the second set of SSBs is different from one of the first set periodicity; and the SSB periodicity of at least another SSB of the second set of SSBs.

In an embodiment, the SSB configuration is transmitted using a predetermined signaling supported by the WD and not supported by at least one other WD served by the network node.

In another embodiment, the SSB configuration further includes an indication indicating at least an SSB that is usable by the WD to perform the at least one measurement.

In some embodiments, the processing circuitry is further configured to update the SSB configuration. The updated SSB configuration includes at least one change to any one of the first set of SSB, the first set periodicity, the second set of SSBs, the second set periodicity, and the SSB periodicity. The determined SSB configuration and the updated SSB configuration are part of a plurality of SSB configurations, and each SSB configuration of the plurality of SSB configurations are one of activated and deactivated by transmitting an activation signaling to the WD. The radio interface is further configured to transmit at least one of the updated SSB configuration and the activation signaling.

According to another aspect, a method in a network node configured to communicate at least with a wireless device (WD) is described. The method includes determining a Synchronization Signal Block (SSB) configuration including a first set of SSBs to be transmitted periodically at a first set periodicity and a second set of SSBs to be transmitted periodically at a second set periodicity. Each SSB of the second set of SSBs is configurable to be transmitted periodically at an SSB periodicity. The method further includes transmitting the SSB configuration to the WD. The transmitted SSB configuration triggering the WD to perform at least one measurement associated with at least one SSB of any one of the first set of SSBs and the second set of SSBs.

In some embodiments, determining the SSB configuration includes determining a first SSB time window, the first SSB time window being configured to occur periodically at a first time window periodicity and being a first time interval including at least one SSB of the first set of SSBs, the first time window periodicity being the first set periodicity; and determining a second SSB time window. The second SSB time window is configured to occur periodically at a second time window periodicity and is a second time interval including at least one SSB of the second set of SSBs. The second time window periodicity is the second set periodicity.

In some other embodiments, the second time interval of the second SSB time window further includes at least one SSB of the first set of SSBs.

In an embodiment, any one of the first SSB time window and the second SSB time window is determined based at least in part on any one of an SSB periodicity parameter defining a periodicity of at least one SSB when the at least one SSB is associated with a first cell; and an SSB Measurement Timing Configuration (SMTC) defining a time window for the WD to measure the at least one SSB when the at least one SSB is associated with a second cell.

In another embodiment, the first cell is a serving cell, and the second cell is a neighboring cell.

In some embodiments, the second time window periodicity is configured one of as an absolute time value; based on the first time window periodicity; and as an offset time value defining a time interval between the first SSB time window and the second SSB time window.

In some other embodiments, the first SSB time window corresponds to one WD, and the second SSB time window corresponds to another WD.

In an embodiment, any one of each SSB of the first set of SSBs and each SSB of the second set of SSBs is transmitted using any one of one antenna port and one corresponding module. The method further includes determining that the WD will not use any one of at least one SSB of the first set of SSBs and at least one SSB of the second set of SSBs; and turning off any one of the one antenna port and the one corresponding module usable to transmit the corresponding SSB.

In another embodiment, the SSB configuration includes a plurality of SSB spatial configurations defining a plurality of wireless signal beams, At least one SSB of the first set of SSBs corresponds to at least a first wireless signal beam of the plurality of wireless signal beams, and at least one SSB of the second set of SSBs corresponds to at least a second wireless signal beam of the plurality of wireless signal beams. The at least first wireless signal beam has a first beam width, and the at least second wireless signal beam has a second beam width.

In some embodiments, the method further includes determining a fraction of a coverage area; determining that one of the WD is located within the fraction of the coverage area and the WD is moving in a direction that indicates neighbor-cell measurements are expected; selecting the at least one SSB of the second set of SSBs corresponding to the at least second wireless signal beam. The second beam width is narrower than the first beam width and narrower than a width associated with the determined fraction of the coverage area. The second wireless signal beam is usable to transmit signaling to the WD while one of the WD is located within the fraction of the coverage area and the WD is moving in the direction that indicates neighbor-cell measurements are expected. Further, the signaling transmitted to the WD.

In some other embodiments, the at least first wireless signal beam has a first angle of departure, and the at least second wireless signal beam has a second angle of departure.

In an embodiment, the SSB periodicity of at least one SSB of the second set of SSBs is different from one of the first set periodicity; and the SSB periodicity of at least another SSB of the second set of SSBs.

In another embodiment, the SSB configuration is transmitted using a predetermined signaling supported by the WD and not supported by at least one other WD served by the network node.

In some embodiments, the SSB configuration further includes an indication indicating at least an SSB that is usable by the WD to perform the at least one measurement.

In some other embodiments, the method further includes updating the SSB configuration, the updated SSB configuration including at least one change to any one of the first set of SSB, the first set periodicity, the second set of SSBs, the second set periodicity, and the SSB periodicity, the determined SSB configuration and the updated SSB configuration being part of a plurality of SSB configurations, each SSB configuration of the plurality of SSB configurations being one of activated and deactivated by transmitting an activation signaling to the WD; and transmitting at least one of the updated SSB configuration and the activation signaling.

According to one aspect, a wireless device (WD) configured to communicate with a network node is described. The WD includes a radio interface configured to receive a Synchronization Signal Block, SSB, configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity; and processing circuitry in communication with the radio interface and configured to perform at least one measurement associated with at least one SSB of any one of the first set of SSBs and the second set of SSBs.

In some embodiments, the SSB configuration includes: a first SSB time window, the first SSB time window being configured to occur periodically at a first time window periodicity and being a first time interval including at least one SSB of the first set of SSBs, the first time window periodicity being the first set periodicity; and a second SSB time window. The second SSB time window is configured to occur periodically at a second time window periodicity and is a second time interval including at least one SSB of the second set of SSBs. The second time window periodicity is the second set periodicity.

In some other embodiments, the second time interval of the second SSB time window further includes at least one SSB of the first set of SSBs.

In an embodiment, any one of the first SSB time window and the second SSB time window is determined based at least in part on any one of: an SSB periodicity parameter defining a periodicity of at least one SSB when the at least one SSB is associated with a first cell; and an SSB Measurement Timing Configuration (SMTC) defining a time window for the WD to measure the at least one SSB when the at least one SSB is associated with a second cell.

In another embodiment, the first cell is a serving cell, and the second cell is a neighboring cell.

In some embodiments, the second time window periodicity is configured one of as an absolute time value; based on the first time window periodicity; and as an offset time value defining a time interval between the first SSB time window and the second SSB time window.

In some other embodiments, the first SSB time window corresponds to one WD, and the second SSB time window corresponds to another WD.

In an embodiment, any one of each SSB of the first set of SSBs and each SSB of the second set of SSBs is transmitted using any one of one antenna port and one corresponding module. The radio interface is further configured to transmit information for the network node to determine that the WD will not use any one of at least one SSB of the first set of SSBs and at least one SSB of the second set of SSBs.

In another embodiment, the SSB configuration includes a plurality of SSB spatial configurations defining a plurality of wireless signal beams. At least one SSB of the first set of SSBs corresponds to at least a first wireless signal beam of the plurality of wireless signal beams, and at least one SSB of the second set of SSBs corresponds to at least a second wireless signal beam of the plurality of wireless signal beams. The at least first wireless signal beam has a first beam width, and the at least second wireless signal beam has a second beam width.

In some embodiments, the radio interface is further configured to transmit additional information for the network node to determine that one of the WD is located within a fraction of a coverage area and the WD is moving in a direction that indicates neighbor-cell measurements are expected; and receive signaling while one of the WD is located within the fraction of the coverage area served by the network node and the WD is moving in the direction that indicates neighbor-cell measurements are expected. The at least one SSB of the second set of SSBs corresponds to the at least second wireless signal beam. The at least second wireless signal beam is selected by the network node to transmit the signaling, and the second beam width is narrower than the first beam width and narrower than a width associated with the fraction of the coverage area.

In some other embodiments, the at least first wireless signal beam has a first angle of departure, and the at least second wireless signal beam has a second angle of departure.

In an embodiment, the SSB periodicity of at least one SSB of the second set of SSBs is different from one of the first set periodicity; and the SSB periodicity of at least another SSB of the second set of SSBs.

In another embodiment, the SSB configuration is received on a transmission that uses a predetermined signaling supported by the WD and not supported by at least one other WD served by the network node.

In some embodiments, the SSB configuration further includes an indication indicating at least an SSB that is usable by the WD to perform the at least one measurement.

In some other embodiments, the radio interface is further configured to receive an updated SSB configuration including at least one change to any one of the first set of SSB, the first set periodicity, the second set of SSBs, the second set periodicity, and the SSB periodicity, the received SSB configuration and the updated SSB configuration being part of a plurality of SSB configurations, each SSB configuration of the plurality of SSB configurations being one of activated and deactivated by receiving an activation signaling; receive the activation signaling; and the processing circuitry is further configured to one of activate and deactivate at least one SSB configuration of the plurality of SSB configurations based on the received activation signaling.

According to another aspect, a method in a wireless device (WD) configured to communicate with a network node is described. The method includes receiving a Synchronization Signal Block (SSB) configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity; and performing at least one measurement associated with at least one SSB of any one of the first set of SSBs and the second set of SSBs.

In some embodiments, the SSB configuration includes a first SSB time window, the first SSB time window being configured to occur periodically at a first time window periodicity and being a first time interval including at least one SSB of the first set of SSBs, the first time window periodicity being the first set periodicity; and a second SSB time window. The second SSB time window is configured to occur periodically at a second time window periodicity and is a second time interval including at least one SSB of the second set of SSBs. The second time window periodicity is the second set periodicity.

In some other embodiments, the second time interval of the second SSB time window further includes at least one SSB of the first set of SSBs.

In an embodiment, any one of the first SSB time window and the second SSB time window is determined based at least in part on any one of an SSB periodicity parameter defining a periodicity of at least one SSB when the at least one SSB is associated with a first cell; and an SSB Measurement Timing Configuration (SMTC) defining a time window for the WD to measure the at least one SSB when the at least one SSB is associated with a second cell.

In another embodiment, the first cell is a serving cell, and the second cell is a neighboring cell.

In some embodiments, the second time window periodicity is configured one of as an absolute time value; based on the first time window periodicity; and as an offset time value defining a time interval between the first SSB time window and the second SSB time window.

In an embodiment, the first SSB time window corresponds to one WD, and the second SSB time window corresponds to another WD.

In another embodiment, any one of each SSB of the first set of SSBs and each SSB of the second set of SSBs is transmitted using any one of one antenna port and one corresponding module. The method further includes transmitting information for the network node to determine that the WD will not use any one of at least one SSB of the first set of SSBs and at least one SSB of the second set of SSBs.

In some embodiments, the SSB configuration includes a plurality of SSB spatial configurations defining a plurality of wireless signal beams. At least one SSB of the first set of SSBs corresponds to at least a first wireless signal beam of the plurality of wireless signal beams, and at least one SSB of the second set of SSBs corresponds to at least a second wireless signal beam of the plurality of wireless signal beams, the at least first wireless signal beam having a first beam width. The at least second wireless signal beam having a second beam width.

In some other embodiments, the method further includes transmitting additional information for the network node to determine that one of the WD is located within a fraction of a coverage area and the WD is moving in a direction that indicates neighbor-cell measurements are expected; and receiving signaling while one of the WD is located within the fraction of the coverage area served by the network node and the WD is moving in the direction that indicates neighbor-cell measurements are expected. The at least one SSB of the second set of SSBs corresponds to the at least second wireless signal beam, and the at least second wireless signal beam is selected by the network node to transmit the signaling. The second beam width is narrower than the first beam width and narrower than a width associated with the fraction of the coverage area.

In an embodiment, the at least first wireless signal beam has a first angle of departure, and the at least second wireless signal beam has a second angle of departure.

In another embodiment, the SSB periodicity of at least one SSB of the second set of SSBs is different from one of the first set periodicity; and the SSB periodicity of at least another SSB of the second set ofSSBs.

In some embodiments, the SSB configuration is received on a transmission that uses a predetermined signaling supported by the WD and not supported by at least one other WD served by the network node.

In some other embodiments, the SSB configuration further includes an indication indicating at least an SSB that is usable by the WD to perform the at least one measurement.

In an embodiment, the method further includes receiving an updated SSB configuration including at least one change to any one of the first set of SSB, the first set periodicity, the second set of SSBs, the second set periodicity, and the SSB periodicity. The received SSB configuration and the updated SSB configuration are part of a plurality of SSB configurations, and each SSB configuration of the plurality of SSB configurations is one of activated and deactivated by receiving an activation signaling. The method further includes receiving the activation signaling; and one of activating and deactivating at least one SSB configuration of the plurality of SSB configurations based on the received activation signaling.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of a network node in communication with a wireless device over a wireless connection according to some embodiments of the present disclosure;

FIG. 3 is a flowchart of an example process in a network node for determining and transmitting an SSB configuration according to some embodiments of the present disclosure; and

FIG. 4 is a flowchart of an example process in a wireless device for receiving an SSB configuration and performing at least one measurement according to some embodiments of the present disclosure;

FIG. 5 is a flowchart of an example process in a network node for determining and transmitting an SSB configuration according to some embodiments of the present disclosure; and

FIG. 6 is an illustration of an example of an SSB configuration including at least first and second sets of SSBs and corresponding time windows according to some embodiments of the present disclosure.

### DETAILED DESCRIPTION

Before describing in detail exemplary embodiments, it is noted that the embodiments reside primarily in combinations of apparatus components and processing steps related to adaptation of SSB periodicity. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise.

It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to adaptation of SSB periodicity, where a first set of SSBs is transmitted at a first periodicity and a second set of SSBs is transmitted at a second periodicity.

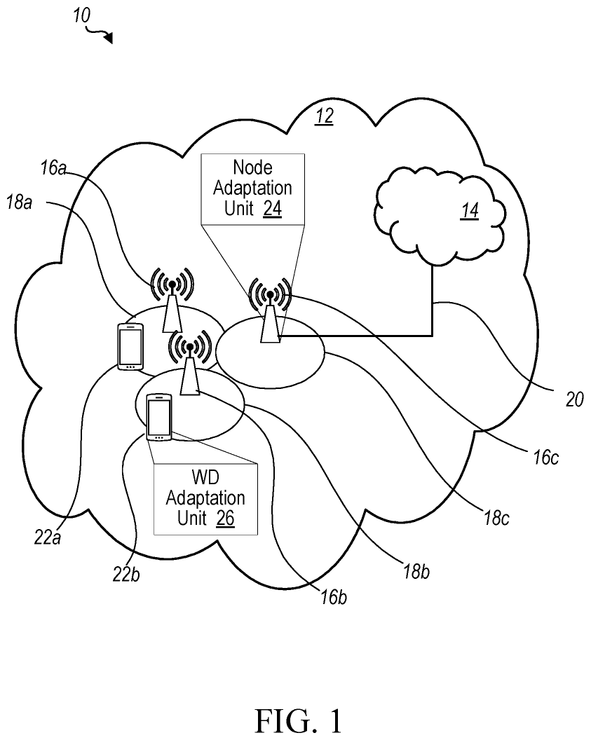

Referring to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (eNB or gNB) is configured to include a node adaptation unit 24 which is configured to at least to determine an SSB configuration that includes a first set of SSBs to be transmitted periodically at a first set periodicity and a second set of SSBs to be transmitted periodically at a second set periodicity and transmit the SSB configuration to the WD. A wireless device 22 is configured to include a WD adaptation unit 26 which is configured to receive the SSB configuration including a first set of SSBs and the second set of SSBs and perform at least one measurement associated with one of at least one SSB of any one of the first set of SSBs and the second set of SSBs.

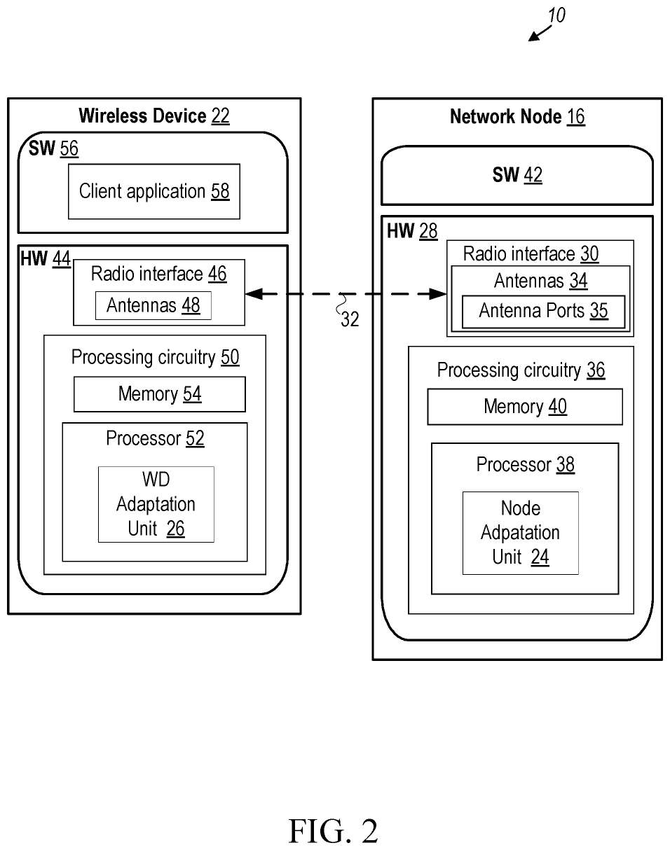

Example implementations, in accordance with an embodiment, of the WD 22 and network node 16 discussed in the preceding paragraphs will now be described with reference to FIG. 2.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves. Further, radio interface 30 includes an array of antenna ports 35, which may also be part of the array of antennas 34.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include node adaptation unit 24 which is configured to at least to determine an SSB configuration that includes a first set of SSBs to be transmitted periodically at a first set periodicity and a second set of SSBs to be transmitted periodically at a second set periodicity and transmit the SSB configuration to the WD

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include WD adaptation unit 26 which is configured to receive the SSB configuration including a first set of SSBs and the second set of SSBs and perform at least one measurement associated with one of at least one SSB of any one of the first set of SSBs and the second set of SSBs.

In one or more embodiments, a module may refer to any of the components of at least one of network node 16 and WD 22. In a nonlimiting example, a module may refer to radio interface 30 and/or antennas 34 and/or antenna ports 35.

In some embodiments, the inner workings of the network node 16 and WD 22 may be as shown in FIG. 2 and independently, the surrounding network topology may be that of FIG. 1.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 1 and 2 show various “units” such as node adaptation unit 24 and WD adaptation unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

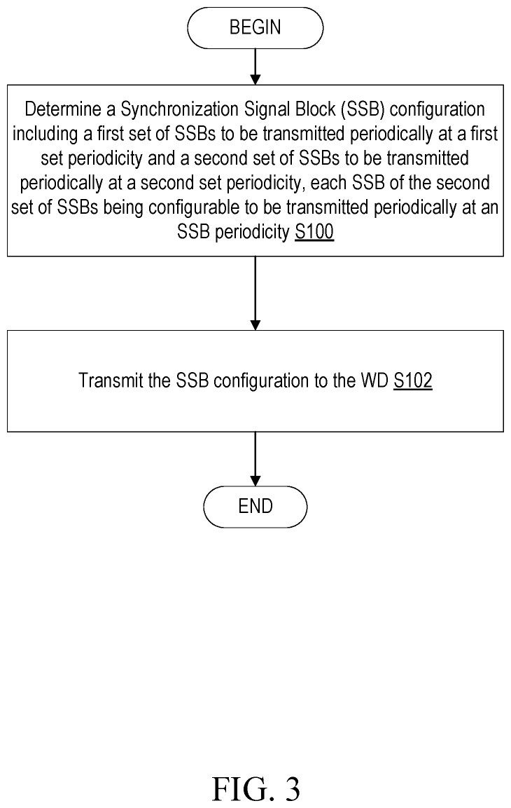

FIG. 3 is a flowchart of an example process in a network node 16 for determining and transmitting an SSB configuration. One or more blocks described herein may be performed by one or more elements of network node 16 such as by one or more of processing circuitry 36 (including the node adaptation unit 24), processor 38, and/or radio interface 30. Network node 16 is configured to determine (Block S100) a Synchronization Signal Block (SSB) configuration including a first set of SSBs to be transmitted periodically at a first set periodicity and a second set of SSBs to be transmitted periodically at a second set periodicity. Each SSB of the second set of SSBs is configurable to be transmitted periodically at an SSB periodicity. In addition, network node 16 is configured to transmit (Block S102) the SSB configuration to the WD 22.

In some embodiments, determining the SSB configuration includes determining a first SSB time window. The first SSB time window is configured to occur periodically at a first time window periodicity and is a first time interval including at least one SSB of the first set of SSBs. The first time window periodicity is the first set periodicity. Determining the SSB configuration further includes determining a second SSB time window. The second SSB time window is configured to occur periodically at a second time window periodicity and is a second time interval including at least one SSB of the second set of SSBs. The second time window periodicity is the second set periodicity.

In some other embodiments, the second time interval of the second SSB time window further includes at least one SSB of the first set of SBBs.

In one embodiment, any one of the first SSB time window and the second SSB time window is determined based at least in part on any one of an SSB periodicity parameter defining a periodicity of at least one SSB when the at least one SSB is associated with a serving cell and an SSB Measurement Timing Configuration (SMTC) defining a time window for the WD to measure the at least one SSB when the at least one SSB is associated with a neighboring cell.

In another embodiment, the second time window periodicity is configured one of as an absolute time value, based on the first time window periodicity, and as an offset time value defining a time interval between the first SSB time window and the second SSB time window.

In some embodiments, the first SSB time window corresponds to one WD 22, and the second SSB time window corresponds to another WD 22.

In some other embodiments, any one of each SSB of the first set of SSBs and each SSB of the second set of SSBs is transmitted using any one of one antenna port 35 and one corresponding module.

The network node 16 and/or the radio interface 30 and/or and the processing circuitry 36 is configured to determine that the WD 22 will not use any one of at least one SSB of the first set of SSBs and at least one SSB of the second set of SSBs. The network node 16 and/or the radio interface 30 and/or and the processing circuitry 36 is configured to turn off any one of the one antenna port 35 and the one corresponding module used to transmit the corresponding SSB.

In one embodiment, the SSB configuration includes a plurality of SSB spatial configurations defining a plurality of wireless signal beams. At least one SSB of first set of SSBs corresponds to at least a first wireless signal beam of the plurality of wireless signal beams. At least one SSB of second set of SSBs corresponding to at least a second wireless signal beam of the plurality of wireless signal beams.

The at least first wireless signal beam has a first beam width, and the at least second wireless signal beam having a second beam width.

In another embodiment, any one of the network node 16, the radio interface 30, and the processing circuitry 36 is configured to determine a fraction of a coverage area 18, determine that one of the WD 2 is located within the fraction of the coverage area and the WD 22 is moving in a direction that indicates neighbor-cell measurements are expected, and select the at least one SSB of the second set of SSBs corresponding to the at least second wireless signal beam. The second beam width is narrower than the first beam width and narrower than a width associated with the determined fraction of the coverage area 18. The second wireless signal beam is usable to transmit signaling to the WD 22 while one of the WD 22 is located within the fraction of the coverage area 18 and the WD 22 is moving in the direction that indicates neighbor-cell measurements are expected. The signaling is transmitted to the WD 22.

In some embodiments, the at least first wireless signal beam has a first angle of departure, and the at least second wireless signal beam has a second angle of departure.

In some other embodiments, the SSB periodicity of at least one SSB of the second set of SSBs is different from one of the first set periodicity and the periodicity of at least another SSB of the second set of SSBs.

In one embodiment, the SSB configuration is transmitted using a predetermined signaling supported by the WD 22 and not supported by other WDs 22.

In another embodiment, the SSB configuration further includes an indication indicating at least an SSB that is usable by the WD 22 to perform measurements.

In some embodiments, any one of the network node 16, the radio interface 30, and the processing circuitry 36 is configured to update the SSB configuration. The updated SSB configuration includes at least one change to any one of the first set of SSB, the first set periodicity, the second set of SSBs, the second set periodicity, and the SSB periodicity. The determined SSB configuration and the updated SSB configuration are part of a plurality of SSB configurations. Each SSB configuration of the plurality of SSB configurations is one of activated and deactivated by transmitting an activation signaling to the WD 22.

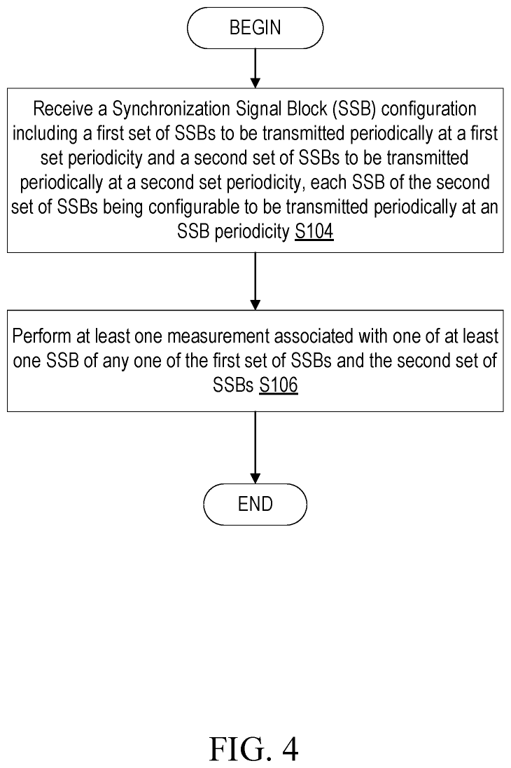

FIG. 4 is a flowchart of an example process in a wireless device 22 for receiving an SSB configuration and performing at least one measurement according to some embodiments of the present disclosure. One or more blocks described herein may be performed by one or more elements of wireless device 22 such as by one or more of processing circuitry 50 (including the WD adaptation unit 26), processor 52, and/or radio interface 46. Wireless device 22 is configured to receive (Block S104) a Synchronization Signal Block (SSB) configuration including a first set of SSBs to be transmitted periodically at a first set periodicity and a second set of SSBs to be transmitted periodically at a second set periodicity. Each SSB of the second set of SSBs is configurable to be transmitted periodically at an SSB periodicity. Wireless device 22 is further configured to perform (Block S106) at least one measurement associated with one of at least one SSB of any one of the first set of SSBs and the second set of SSBs.

In some embodiments, the SSB configuration includes a first SSB time window. The first SSB time window is configured to occur periodically at a first time window periodicity and is a first time interval that includes at least one SSB of the first set of SSBs. The first time window periodicity being the first set periodicity. The SSB configuration further includes a second SSB time window. The second SSB time window is configured to occur periodically at a second time window periodicity and is a second time interval that includes at least one SSB of the second set of SSBs. The second time window periodicity is the second set periodicity.

In some other embodiments, the second time interval of the second SSB time window further includes at least one SSB of the first set of SBBs.

In one embodiment, any one of the first SSB time window and the second SSB time window is determined based at least in part on any one of an SSB periodicity parameter defining a periodicity of at least one SSB when the at least one SSB is associated with a serving cell and an SSB Measurement Timing Configuration (SMTC) defining a time window for the WD to measure the at least one SSB when the at least one SSB is associated with a neighboring cell.

In another embodiment, the second time window periodicity is configured one of as an absolute time value, based on the first time window periodicity, and as an offset time value defining a time interval between the first SSB time window and the second SSB time window.

In some embodiments, the first SSB time window corresponds to one WD 22, and the second SSB time window corresponds to another WD 22.

In some other embodiments, any one of each SSB of the first set of SSBs and each SSB of the second set of SSBs is transmitted using any one of one antenna port 35 and one corresponding module.

Any one of the WD 22, the radio interface 46, and the processing circuitry 50 is configured to provide information for the network node 16 to determine that the WD 22 will not use any one of at least one SSB of the first set of SSBs and at least one SSB of the second set of SSBs.

In one embodiment, the SSB configuration includes a plurality of SSB spatial configurations defining a plurality of wireless signal beams. At least one SSB of first set of SSBs corresponds to at least a first wireless signal beam of the plurality of wireless signal beams. At least one SSB of second set of SSBs corresponds to at least a second wireless signal beam of the plurality of wireless signal beams. The at least first wireless signal beam has a first beam width, and the at least second wireless signal beam has a second beam width.

In another embodiment, any one of the WD 22, the radio interface 46, and the processing circuitry 50 is configured to provide additional information for the network node 16 to determine that one of the WD 22 is located within a fraction of a coverage area and the WD 22 is moving in a direction that indicates neighbor-cell measurements are expected. Any one of the WD 22, the radio interface 46, and the processing circuitry 50 is further configured to receive signaling while one of the WD 22 is located within the fraction of the coverage area served by the network node 16 and the WD 22 is moving in the direction that indicates neighbor-cell measurements are expected. The at least one SSB of the second set of SSBs corresponds to the at least second wireless signal beam. The at least second wireless signal beam is selected by the network node 16 to transmit the signaling. The second beam width being narrower than the first beam width and narrower than a width associated with the fraction of the coverage area 18.

In some embodiments, the at least first wireless signal beam has a first angle of departure, and the at least second wireless signal beam has a second angle of departure.

In some other embodiments, the SSB periodicity of at least one SSB of the second set of SSBs is different from one of the first set periodicity and the periodicity of at least another SSB of the second set of SSBs.

In one embodiment, the SSB configuration is received on a transmission that uses a predetermined signaling supported by the WD 22 and not supported by other WDs 22.

In another embodiment, the SSB configuration further includes an indication indicating at least an SSB that is usable by the WD 22 to perform measurements.

In some embodiments, any one of the WD 22, the radio interface 46, and the processing circuitry 50 is configured to receive an updated SSB configuration including at least one change to any one of the first set of SSB, the first set periodicity, the second set of SSBs, the second set periodicity, and the SSB periodicity. The received SSB configuration and the updated SSB configuration are part of a plurality of SSB configurations. Each SSB configuration of the plurality of SSB configurations is one of activated and deactivated by receiving an activation signaling. Any one of the WD 22, the radio interface 46, and the processing circuitry 50 is configured to receive the activation signaling and one of activate and deactivate at least one SSB configuration of the plurality of SSB configurations based on the received activation signaling.

In some other embodiments, any one of the first SSB time window and the second SSB time window is determined based at least in part on any one of an SSB periodicity parameter defining a periodicity of at least one SSB when the at least one SSB is associated with a first cell; and an SSB Measurement Timing Configuration (SMTC) defining a time window for the WD 22 to measure the at least one SSB when the at least one SSB is associated with a second cell.

In an embodiment, the first cell is a serving cell, and the second cell is a neighboring cell.

In another embodiment, any one of each SSB of the first set of SSBs and each SSB of the second set of SSBs is transmitted using any one of one antenna port and one corresponding module. The method further includes transmitting information for the network node 16 to determine that the WD 22 will not use any one of at least one SSB of the first set of SSBs and at least one SSB of the second set of SSBs.

In some embodiments, the method further includes transmitting additional information for the network node 16 to determine that one of the WD 22 is located within a fraction of a coverage area and the WD 22 is moving in a direction that indicates neighbor-cell measurements are expected; and receiving signaling while one of the WD 22 is located within the fraction of the coverage area served by the network node 16 and the WD 22 is moving in the direction that indicates neighbor-cell measurements are expected. The at least one SSB of the second set of SSBs correspond to the at least second wireless signal beam. The at least second wireless signal beam is selected by the network node 16 to transmit the signaling, and the second beam width is narrower than the first beam width and narrower than a width associated with the fraction of the coverage area.

In some other embodiments, the SSB configuration is received on a transmission that uses a predetermined signaling supported by the WD 22 and not supported by at least one other WD 22 served by the network node 16.

In an embodiment, the SSB configuration further includes an indication indicating at least an SSB that is usable by the WD to perform the at least one measurement.

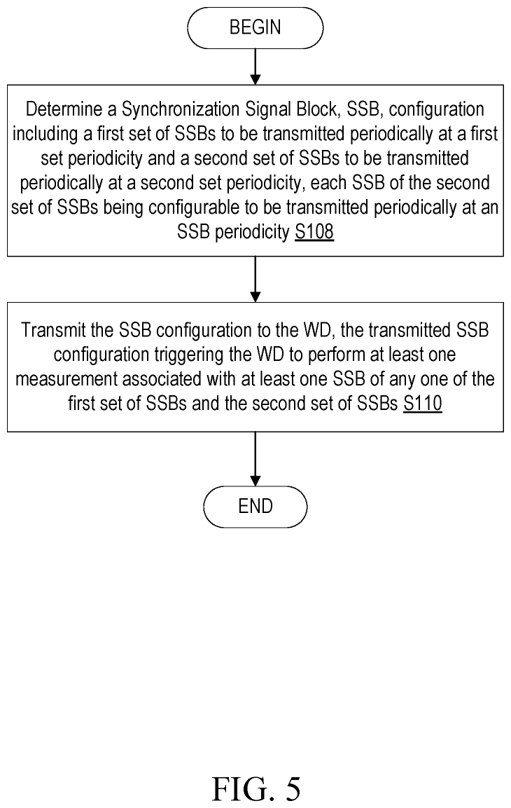

FIG. 5 is a flowchart of an example process in a network node 16 for determining and transmitting an SSB configuration. One or more blocks described herein may be performed by one or more elements of network node 16 such as by one or more of processing circuitry 36 (including the node adaptation unit 24), processor 38, and/or radio interface 30. Network node 16 is configured to determine (Block S108) a Synchronization Signal Block (SSB) configuration including a first set of SSBs to be transmitted periodically at a first set periodicity and a second set of SSBs to be transmitted periodically at a second set periodicity. Each SSB of the second set of SSBs is configurable to be transmitted periodically at an SSB periodicity. Network node 16 is further configured to transmit (Block S110) transmit the SSB configuration to the WD 22, where the transmitted SSB configuration triggers the WD 22 to perform at least one measurement associated with at least one SSB of any one of the first set of SSBs and the second set of SSBs.

In some embodiments, any one of the first SSB time window and the second SSB time window is determined based at least in part on any one of: an SSB periodicity parameter defining a periodicity of at least one SSB when the at least one SSB is associated with a first cell; and an SSB Measurement Timing Configuration, SMTC, defining a time window for the WD to measure the at least one SSB when the at least one SSB is associated with a second cell.

In some other embodiment, the first cell is a serving cell, and the second cell is a neighboring cell.

In an embodiment, any one of each SSB of the first set of SSBs and each SSB of the second set of SSBs is transmitted using any one of one antenna port and one corresponding module. In addition, the method further includes determining that the WD 22 will not use any one of at least one SSB of the first set of SSBs and at least one SSB of the second set of SSBs; and turning off any one of the one antenna port and the one corresponding module usable to transmit the corresponding SSB.

In another embodiment, the SSB configuration is transmitted using a predetermined signaling supported by the WD 22 and not supported by at least one other WD 22 served by the network node 16.

In some embodiments, the SSB configuration further includes an indication indicating at least an SSB that is usable by the WD 22 to perform the at least one measurement.

In some other embodiments, the method further includes updating the SSB configuration, where the updated SSB configuration includes at least one change to any one of the first set of SSB, the first set periodicity, the second set of SSBs, the second set periodicity, and the SSB periodicity. The determined SSB configuration and the updated SSB configuration being part of a plurality of SSB configurations, where each SSB configuration of the plurality of SSB configurations is one of activated and deactivated by transmitting an activation signaling to the WD 22. The method further includes transmitting at least one of the updated SSB configuration and the activation signaling.

Having described the general process flow of arrangements of the disclosure and having provided examples of hardware and software arrangements for implementing the processes and functions of the disclosure, the sections below provide details and examples of arrangements for adaptation of SSB periodicity.

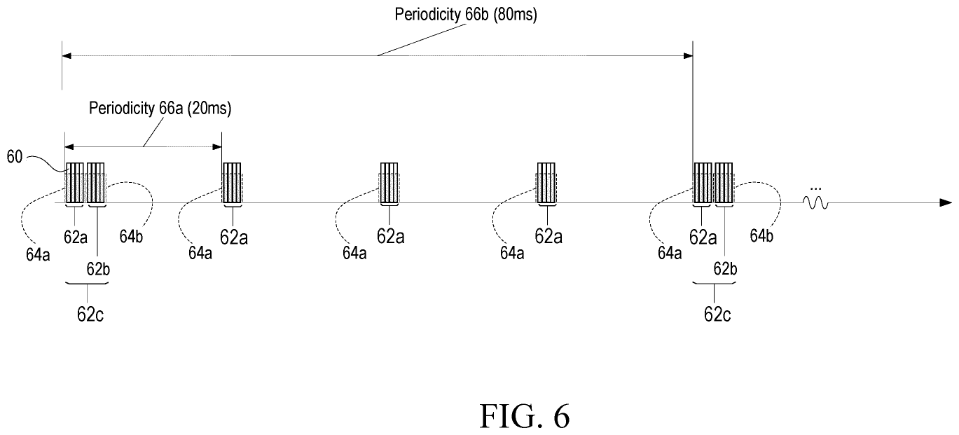

FIG. 6 shows an example of an SSB configuration including at least a first and second sets of SSBs and corresponding time windows. More specifically, the SSB configuration includes at least one SSB 60, a plurality of sets of SSBs 62, e.g., a first set of SSBs 62a and a second set of SSBs 62b, a plurality of time windows such as a first SSB time window 64a and a second SSB time window 64b. In this nonlimiting example, although the sets of SSBs 62 are shown as including four SSBs 60, the sets of SSBs 62 are not limited to including only 4 SSBs and may include any number of SSBs 60 and/or include SSBs 60 from another set of SSBs 62. As shown in FIG. 6, the second set of SSBs 62b may include SSBs 60 from the first set of SSBs 62a, e.g., the second set of SSBs 62b may include all SSB 60 of the first set of SSBs 62a, which is show as for ease of understanding as a third set of SSBs 62c. Put differently, the second set of SSBs 62b may include the SSBs 60 included in the third set of SSBs 62c.

Further, in this non limiting example, the first SSB time window 64a and the second SSB time window 64b are an SMTC1 and an SMTC2, respectively. However, the plurality of time windows, such as the first SSB time window 64a and the second SSB time window 64b, are not limited to being SMTC1 and SMTC2 and may be any kind of time window. In this nonlimiting example, time window 64b may include SSBs 60 of the second set of SSBs 62b and/or SSBs 60 of the first set of SSBs 62a.

In addition, an SSB 60, a set of SSBs 62, and/or an SSB time window 64 may be configured to have a periodicity 66, which may refer to one or more periodicities such as periodicity 66a, 66b, 66c. For example, SSB time window 64a (and/or SSB 60 and/or the first set of SSB 62a) may have a periodicity 66a equal to 20 ms, and SSB time window 64b (and SSB time window) may have a periodicity 66b equal to 80 ms. Periodicity 66, such as periodicities 66a and 66b, are not limited being equal to 20 ms and 80 ms and may have any other value.

Some embodiments provide a network node 16 that may determine/configure a plurality of SSB sets 62. For example, network node 16 may determine/configure a first set of SSBs 62a by configuring parameters such as ssb-PositionsInBurst/ssb-PeriodicityServingCell parameters for a certain cell, e.g., for a serving cell associated with the network node 16. For neighboring cells associated with the network node 16, the network node 16 may configure a first set of SSB time windows 64, e.g., SMTC time windows, with the same periodicities, e.g., 20 ms that may be intended as a coverage SSBs. The coverage SSBs may refer to SSBs 60 intended for “legacy” WDs 22, e.g., such as 3GPP Rel. 15/16/17 compliant WDs 22. Further, the coverage SSBs may be intended for legacy WDs 22 so that the legacy WDs 22 can find the SSBs 60 that are configured/transmitted according to the current 3GPP Technical Specifications. Coverage SSBs are also intended so that the WD performance within a given area where the SSBs 60 are provided is not impacted.

The network node 16 may also determine/configure additional sets of SSBs of the plurality of sets of SSBs 62, e.g., a second and third set of SSBs 62b, 62c, and/or additional parameter including presence and timing parameters. For example, for neighboring cells, network node 16, e.g., a gNB, may configure per cell a WD 22 with neighboring SMTCs and an associated presence indicator similar to ssb-PositionsInBurst or SSBsToMeasure. Each of the sets including SSBs timing and/or presence parameters may be configured with a different periodicity and/or presence. For example, a first time window, e.g., a first SMTC time window, can be configured with four SSBs 60 present with periodicity 66a of 20 ms, and a second time window, e.g., a second SMTC time window, with eight SSBs 60 in total or four SSBs 60 in addition to the four SSBs 60 of the first time window, where the second time window has a periodicity 66b of 80 ms. A third SSB time window, e.g., a third SMTC time window, with additional eight SSBs 60 and periodicity of 160 ms, and a fourth time window, e.g., a fourth SMTC time window, leading to that a total of sixty-four SSBs 60 are periodically present every 320 ms. In other words, network node 16 may configure SSBs 60 (and/or sets of SSBs 62 and/or SSB time windows 64) with higher than 160 ms periodicity. As shown in FIG. 6, SSB time windows 64a and 64b, e.g., SMTC1 and SMTC2 time windows, are configured for a/several neighbor cell(s). The first SSB time window 64a, e.g., SMTC1 time window, includes four SSBs active and is configured to have a periodicity 66a of 20 ms, while the second time window, e.g., SMTC2 time window, includes another four SSBs configured with a periodicity of 80 ms.

In some embodiments, the periodicity 66 of an SSB time window such as an SMTC time window can be configured with an absolute time value, e.g., 20 ms and/or 80 ms. In some other embodiments, the periodicity 66 of one SSB time window 64 such as an SMTC window can be configured in a relation with the periodicity 66 of another SSB time window 64, e.g., the periodicity 66a of the first set of SSBs 62a and/or of the first SSB time window 64a. For example, a time window, e.g., an SMTC time window, can be configured as an integer or a fraction value, X, where X means the periodicity of the time window is X times that of the periodicity of the first set of SSBs 62a and/or of the first SSB time window 64a. In this nonlimiting example, the value of X for the first SSB time window 64a, e.g., the first SMTC time window, and the second SSB time window, e.g., the second SMTC time window, is 1 and 4, respectively. A SMTC time window may refer to a set of SMTC time windows, where each SMTC is separated in time by a periodicity.

Although the examples described above refer to SSBs 60 of neighboring cells, the principles of the present disclosure are also applicable to any other kind of cell including serving cells. For example, for a serving cell, a plurality of sets of ssb-PeriodicityServingCell/ssb-PeriodicityServing parameter combinations may be configured, e.g., to form a transmission time window similar to a SMTC time window. For each parameter combination, an offset may be defined to configure a start of an SSB time window 64. The offset may either be relative another time window 60 and/or specified in absolute time on an SFN cycle. For ease of understanding, the term SSB time window is used interchangeably for both serving and neighboring cells.

Further, network node 16 may provide a configuration, including a configuration indicating SSB time window, e.g., via higher-layer signaling such as Managed Information Block (MIB) or System Information Block (SIB) broadcasting, dedicated signaling, and/or RRC configuration. For example, network node 16 may only configure a group of SSB time windows such as second, third, and fourth SSB time windows for selected WDs 22 (e.g., 3GPP Rel. 18+WDs 22 and/or WDs 22 with a predetermined capability, etc.). In other words, the network node 16 may provide predetermined signaling such as dedicated signaling. For example, a 3GGP Rel. 18+WD 22 may first connect to the cell by finding an SSB 60 in a first SSB time window 64a, and after a connection is established, become aware of the other SSB time windows 64. The WD 22 may then determine whether to perform at least one measurement, e.g., one or more RRM measurements, Time and/or Frequency (T/F) synchronization, Adaptive Gain Control (AGC), etc., based on the SSBs 60 in other SSB time windows 64, e.g., in the third SSB time window 64c. Network node 16 may only use four antenna ports 35 to transmit the SSBs 60 in a first set of SSBs, eight ports for the second set of SSBs, 16 for the third set of SSBs and 64 for the fourth set of SSBs. Further, network node 16 may turn off and/or change power parameters associated with at least one component/element of network node 16, e.g., antenna ports 35 that are not used such as not used to transmit the second set of SSBs during the 80 ms silent period. For ease of understanding, turning off a component/element of network node 16 may refer to turning off/controlling power parameters of at least one element of the network node 16. In some embodiments, network node 16 may turn off an element of the network node 16, when the element is not used for other processes, e.g., PRACH, transmission/reception of data, control channels, and/or reference signal reception/transmissions. Depending on time availability (e.g., an expected absence time of WDs requiring SSB sets other than a first set of SBs) and a time remaining until a next transmission with a large number of ports, network node 16 may turn off additional elements, e.g., modules, of the network node 16 as well such as chipsets associated with beamforming, associated clock, the Alternate/Direct current Converters (ADCs), etc. In sum, network node 16 can be configured to operate in a lower power mode when elements of the network node 16 are turned off than when elements are not turned off, e.g., when sixty-four antenna ports 35 are active/turned on.

In another embodiment, an SSB configuration, e.g., a configuration associated with a first set of SSBs 62), may include SSB spatial configurations with a first beam width such as a beam that is the widest beam of all possible widths (e.g., covering ¼ of a cell area). The SSB configuration may include additional sets of SSBs, e.g., second, third sets of SSBs, which may comprise SSBs with respectively narrower beam widths where a full beam set may cover a cell area (e.g., ⅛ of the cell in a second set of SSBs, 1/16 in the third set, etc.). WDs 22 capable of receiving the above described signaling can thereby utilize the larger (higher-resolution) sets of SSB and/or support accurate SSB-based beam establishment including in early stages of a connection procedure. WDs 22 may also perform accurate SSB-based measurements due to SSB quality. In some embodiments, network node 16 may transmit the second, third sets of SSBs according to a regular pattern without considering WD positions. A regular pattern may refer to a pattern that covers the entirety of a cell area, where each beam is similar to (i.e., sharing at least one characteristic with) other beams in terms of beam shape and beam width.

While in a high-port mode, e.g., immediately before and after SSB occasions including SSB sets other than one, the network node 16 may transmit lower SSB sets using a full number of antenna ports 35 but applying appropriate dual-polarized beamforming for transmissions of SSBs with beam widths wider than a predetermined beam width (e.g., a default beam with) produced by a selected number of ports. High-port mode may refer to a mode where a predetermined number/quantity of ports is exceeded. Further, one or more SSB sets may have a lower set number than other SSB sets such as a second SSB set being a lower SSB set than a third SSB set. While in reduced-port mode, e.g., in vicinity SSB bursts excluding one or more higher sets of SSB, network node 16 may transmit lower sets of SSB without applying dual-polarized beamforming if the relevant SSB beam widths correspond to a conventional, or default, beam width produced by a number of antenna ports currently active. Reduced-port mode may refer to a mode where a predetermined number/quantity of ports is not exceeded. Dual-polarized beamforming may refer to an arrangement of Tx/Rx antenna elements with two polarizations radiating in different spatial planes/directions e.g., horizontal and vertical respectively. In some other embodiments, the beams associated with sets of SSBs 62 other than the first set of SSBs, e.g., second, third sets, network node 16 may be configured so that set of SSBs (i.e., associated beams) are made narrower than 1/N_k, where N_k is the size of the k-th set, of a coverage area 18, e.g., a cell coverage area. The sets of SSBs of than the first set may be chosen to include a subset of possible narrower beams so as to illuminate/serve cell areas with known WD presence and/or in directions where neighbor-cell measurements are expected (e.g., towards active neighbor cells). In other words, in these embodiments, SSB bursts included in sets of SSBs of than the first set do not cover an entire cell area and/or cover areas where WDs capable of utilizing the SSBs 60 are present. Further, network node 16 may obtain information about areas with WD presence based on previous WD position information, PRACH transmission, Angle of Arrival (AoA), etc.

In one embodiment, network node 16 configures a first set of SSBs 62a in first SSB time window 64a with the same periodicities, e.g., 20 ms, which may be intended as coverage SSBs. Additionally, network node 16 configures at least a second SSB time window 64b with a number of SSBs 60, where each SSB 60 of the second SSB time window 64b may be configured at least an SSB periodicity, e.g., an individual periodicity. For example, a first SSB time window may include four SSBs 60 with periodicity of 20 ms, and the second and third SSB time windows 64b, 64c may include an additional eight SSBs 60 with different periodicity than the periodicity of 20 ms of the SSBs of the first SSB time window 64a. In a nonlimiting example, four SSBs 60 are configured in a second SSB time window 64b with a periodicity of 160 ms, and an additional four SSBs 60 with a periodicity of 320 ms in a third SSB time window 64c.

In another embodiment, every set of SSBs 62 may include beams that cover 1/N (here, %) of the cell area and together cover a coverage area 18, e.g., an entire cell, where covering the coverage area 18 may be defined, for example, as providing a Reference Signal Received Power (RSRP) value above a threshold at any point in the coverage area 18, the cell. Different sets of SSBs 62 may be shifted with respect to each other in terms of an AoD angle so that different beams provide peak beam gains in slightly different directions. A WD 22 capable of the signaling described above can then detect a better beam in higher sets of SSBs 62, i.e., a beam more accurately directed in the direction of the WD 22 than a baseline beam and/or the best beam of the first set of SSBs 60a. Therefore, the WD 22 may benefit from higher effective SSB resolution.

In some embodiments, the sets of SSBs other than the first set may include beams that are narrower than beams of the first set, e.g., four beams in a second set of SSBs do not cover the full cell area. As previously described, network node 16 may transmit the narrower beams in directions where WD presence is anticipated and/or exclude at least one direction where the WD 22 is not anticipated.

As described above, network node 16 may provide the SSB configuration through higher layer signaling, e.g., MIB or SIB broadcasting, dedicated signaling, and/or RRC configuration. In a nonlimiting example, the network node 16 may only configure some SSB time windows 64 with individual SSB periodicities for selected WDs 22 (e.g., 3GPP Rel. 18+WD 22) and/or use a dedicated signaling approach. The selected WDs 22 may first connect to a cell by finding an SSB 60 in the first SSB time window 64a, and following the connection, become aware of the second SSB window 64b, and determine whether to perform RRM measurements, T/F synch, AGC, etc., based on the one or more SSBs 60, e.g., in the second SSB time window 64b. The network node 16 may additionally configure the WD 22 with an indication indicating on which SSBs to perform measurements. Network node 16 may then be aware of which SSBs 60 are used by each WD 22. If some SSBs 60 are not used, network node 16 may remove a configuration associated with the SSBs not being used and/or turn off associated elements of the network node 16, e.g., antenna ports 35, to save energy.

In some other embodiments, except SSB time windows 64 including coverage SSBs 60, reconfiguration of other SSB time windows 64 and/or SSBs 60 can be communicated to the WD 22 using existing channels, e.g., SI update or RRC reconfiguration. In one embodiment, WD 22 may determine whether to reacquire updated configurations. In another embodiment, L1/L2 based signaling can be used to activate and/or deactivate one or more configurations. For example, in connected mode, Downlink Control Information (DCI) based and/or Media Access Control (MAC) Control Element (CE) based signaling may be used by network node 16 and/or WD 22 for activation/deactivation. In idle mode, paging and/or other type of available DCIs, and/or sequences such as paging early indicator can be used.

In some embodiments, a set of (e.g., cell coverage) SSBs may be configured/transmitted (e.g., by network node 16) with a periodicity (e.g., regular periodicity such as 20 ms). Additional sets of SSBs may be configured/transmitted with longer periodicity (e.g., 80 ms) for power saving purposes. The additional sets of SSBs may be usable for neighbor cells measurements or for a same serving cell. Some of the additional sets of SSBs may be turned off (e.g., not transmitted) if there are no WD/UE activities associated with the SSBs. The additional SSBs may be associated with narrower beams for other SSB based measurements. Further, the additional SSBs may have different periodicities and point to different directions. The additional SSBS (and/or any other SSBs) may be signaled via system information block (SIB) and/or RRC and/or activated/deactivated via Layer 1 and/or Layer 2 (L1/L2) signaling.

In some other embodiments, methods and/or mechanisms used by WD 22 are describe and may include selecting one or more SSBs (e.g., appropriate SSBs) for measurement purposes.

In other words, the embodiments of the present disclosure are beneficial at least because more than one SSBs may have different periodicities, i.e., overcoming the drawbacks of typical systems that use a single periodicity configured for all SSBs (e.g., same periodicity for all the SSBs within a burst). Further, SSBs within any set of SSBs (i.e., group of SSBs) and/or a time window of SSBs may be configured to have different SSBs.

The following is a list of example embodiments:

Embodiment A1. A network node configured to communicate at least with a wireless device (WD), the network node configured to, and/or comprising a radio interface and/or comprising processing circuitry configured to: determine a Synchronization Signal Block (SSB) configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity; and transmit the SSB configuration to the WD.

Embodiment A2. The network node of Embodiment A1, wherein determining the SSB configuration includes: determining a first SSB time window, the first SSB time window being configured to occur periodically at a first time window periodicity and being a first time interval including at least one SSB of the first set of SSBs, the first time window periodicity being the first set periodicity; determining a second SSB time window, the second SSB time window being configured to occur periodically at a second time window periodicity and being a second time interval including at least one SSB of the second set of SSBs, the second time window periodicity being the second set periodicity.

Embodiment A3. The network node of Embodiment A2, wherein the second time interval of the second SSB time window further includes at least one SSB of the first set of SBBs.

Embodiment A4. The network node of any one of Embodiments A2 and A3, wherein any one of the first SSB time window and the second SSB time window is determined based at least in part on any one of: an SSB periodicity parameter defining a periodicity of at least one SSB when the at least one SSB is associated with a serving cell; and an SSB Measurement Timing Configuration (SMTC) defining a time window for the WD to measure the at least one SSB when the at least one SSB is associated with a neighboring cell.

Embodiment A5. The network node of any one of Embodiments A2-A4, wherein the second time window periodicity is configured one of: as an absolute time value; based on the first time window periodicity; and as an offset time value defining a time interval between the first SSB time window and the second SSB time window.

Embodiment A6. The network node of any one of Embodiments A2-A5, wherein the first SSB time window corresponds to one WD, and the second SSB time window corresponds to another WD.

Embodiment A7. The network node of any one of Embodiments A1-A6, wherein any one of each SSB of the first set of SSBs and each SSB of the second set of SSBs is transmitted using any one of one antenna port and one corresponding module, and one of the network node, the radio interface, and the processing circuitry is configured to: determine that the WD will not use any one of at least one SSB of the first set of SSBs and at least one SSB of the second set of SSBs; and turn off any one of the one antenna port and the one corresponding module usable to transmit the corresponding SSB.

Embodiment A8. The network node of any one of Embodiments A1-A7, wherein the SSB configuration includes a plurality of SSB spatial configurations defining a plurality of wireless signal beams, at least one SSB of first set of SSBs corresponding to at least a first wireless signal beam of the plurality of wireless signal beams, at least one SSB of second set of SSBs corresponding to at least a second wireless signal beam of the plurality of wireless signal beams, the at least first wireless signal beam having a first beam width, the at least second wireless signal beam having a second beam width.

Embodiment A9. The network node of Embodiment A8, wherein any one of the network node, the radio interface, and the processing circuitry is configured to: determine a fraction of a coverage area; determine that one of the WD is located within the fraction of the coverage area and the WD is moving in a direction that indicates neighbor-cell measurements are expected; select the at least one SSB of the second set of SSBs corresponding to the at least second wireless signal beam, the second beam width being narrower than the first beam width and narrower than a width associated with the determined fraction of the coverage area, the second wireless signal beam being usable to transmit signaling to the WD while one of the WD is located within the fraction of the coverage area and the WD is moving in the direction that indicates neighbor-cell measurements are expected; and transmit the signaling to the WD.

Embodiment A10. The network node of any one of Embodiments A8 and A9, wherein the at least first wireless signal beam has a first angle of departure, and the at least second wireless signal beam has a second angle of departure.

Embodiment A11. The network node of any one of Embodiments A1-A10, wherein the SSB periodicity of at least one SSB ofthe second set of SSBs is different from one of:

the first set periodicity; and the periodicity of at least another SSB of the second set of SSBs.

Embodiment A12. The network node of any one of Embodiments A1-A11, wherein the SSB configuration is transmitted using a predetermined signaling supported by the WD and not supported by other WDs.

Embodiment A13. The network node of any one of Embodiments A1-A12, wherein the SSB configuration further includes an indication indicating at least an SSB that is usable by the WD to perform measurements.

Embodiment A14. The network node of any one of Embodiments A1-A13, wherein any one of the network node, the radio interface, and the processing circuitry is configured to: update the SSB configuration, the updated SSB configuration including at least one change to any one of the first set of SSB, the first set periodicity, the second set of SSBs, the second set periodicity, and the SSB periodicity, the determined SSB configuration and the updated SSB configuration being part of a plurality of SSB configurations, each SSB configuration of the plurality of SSB configurations being one of activated and deactivated by transmitting an activation signaling to the WD.

Embodiment B1. A method implemented in a network node configured to communicate at least with a wireless device (WD), the method comprising: determining a Synchronization Signal Block (SSB) configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity; and transmitting the SSB configuration to the WD.

Embodiment B2. The method of Embodiment B1, wherein determining the SSB configuration includes: determining a first SSB time window, the first SSB time window being configured to occur periodically at a first time window periodicity and being a first time interval including at least one SSB of the first set of SSBs, the first time window periodicity being the first set periodicity; determining a second SSB time window, the second SSB time window being configured to occur periodically at a second time window periodicity and being a second time interval including at least one SSB of the second set of SSBs, the second time window periodicity being the second set periodicity.

Embodiment B3. The method of Embodiment B2, wherein the second time interval of the second SSB time window further includes at least one SSB of the first set of SBBs.

Embodiment B4. The method of any one of Embodiments B2 and B3, wherein any one of the first SSB time window and the second SSB time window is determined based at least in part on any one of: an SSB periodicity parameter defining a periodicity of at least one SSB when the at least one SSB is associated with a serving cell; and an SSB Measurement Timing Configuration (SMTC) defining a time window for the WD to measure the at least one SSB when the at least one SSB is associated with a neighboring cell.

Embodiment B5. The method of any one of Embodiments B2-B4, wherein the second time window periodicity is configured one of: as an absolute time value; based on the first time window periodicity; and as an offset time value defining a time interval between the first SSB time window and the second SSB time window.

Embodiment B6. The method of any one of Embodiments B2-B5, wherein the first SSB time window corresponds to one WD, and the second SSB time window corresponds to another WD.

Embodiment B7. The method of any one of Embodiments B1-B6, wherein any one of each SSB of the first set of SSBs and each SSB of the second set of SSBs is transmitted using any one of one antenna port and one corresponding module, and the method further includes: determining that the WD will not use any one of at least one SSB of the first set of SSBs and at least one SSB of the second set of SSBs; and turning off any one of the one antenna port and the one corresponding module used to transmit the corresponding SSB.

Embodiment B8. The method of any one of Embodiments B1-B7, wherein the SSB configuration includes a plurality of SSB spatial configurations defining a plurality of wireless signal beams, at least one SSB of first set of SSBs corresponding to at least a first wireless signal beam of the plurality of wireless signal beams, at least one SSB of second set of SSBs corresponding to at least a second wireless signal beam of the plurality of wireless signal beams, the at least first wireless signal beam having a first beam width, the at least second wireless signal beam having a second beam width.

Embodiment B9. The method of Embodiment B8, wherein the method further includes: determining a fraction of a coverage area; determining that one of the WD is located within the fraction of the coverage area and the WD is moving in a direction that indicates neighbor-cell measurements are expected; selecting the at least one SSB of the second set of SSBs corresponding to the at least second wireless signal beam, the second beam width being narrower than the first beam width and narrower than a width associated with the determined fraction ofthe coverage area, the second wireless signal beam being usable to transmit signaling to the WD while one of the WD is located within the fraction of the coverage area and the WD is moving in the direction that indicates neighbor-cell measurements are expected; and transmitting the signaling to the WD.

Embodiment B10. The method of any one of Embodiments B8 and B9, wherein the at least first wireless signal beam has a first angle of departure, and the at least second wireless signal beam has a second angle of departure.

Embodiment B11. The method of any one of Embodiments B1-B10, wherein the SSB periodicity of at least one SSB of the second set of SSBs is different from one of: the first set periodicity; and the periodicity of at least another SSB of the second set of SSBs.

Embodiment B12. The method of any one of Embodiments B1-B11, wherein the SSB configuration is transmitted using a predetermined signaling supported by the WD and not supported by other WDs.

Embodiment B13. The method of any one of Embodiments B1-B12, wherein the SSB configuration further includes an indication indicating at least an SSB that is usable by the WD to perform measurements.

Embodiment B14. The method of any one of Embodiments B1-B13, wherein method further includes:

updating the SSB configuration, the updated SSB configuration including at least one change to any one of the first set of SSB, the first set periodicity, the second set of SSBs, the second set periodicity, and the SSB periodicity, the determined SSB configuration and the updated SSB configuration being part of a plurality of SSB configurations, each SSB configuration of the plurality of SSB configurations being one of activated and deactivated by transmitting an activation signaling to the WD.

Embodiment C1. A wireless device (WD) configured to communicate with a network node, the WD configured to, and/or comprising a radio interface and/or processing circuitry configured to: receive a Synchronization Signal Block (SSB) configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity; and perform at least one measurement associated with at least one SSB of any one of the first set of SSBs and the second set of SSBs.

Embodiment C2. The WD of Embodiment C1, wherein the SSB configuration includes:

a first SSB time window, the first SSB time window being configured to occur periodically at a first time window periodicity and being a first time interval including at least one SSB of the first set of SSBs, the first time window periodicity being the first set periodicity; and a second SSB time window, the second SSB time window being configured to occur periodically at a second time window periodicity and being a second time interval including at least one SSB of the second set of SSBs, the second time window periodicity being the second set periodicity.

Embodiment C3. The WD of Embodiment C2, wherein the second time interval ofthe second SSB time window further includes at least one SSB of the first set of SBBs.

Embodiment C4. The WD of any one of Embodiments C2 and C3, wherein any one of the first SSB time window and the second SSB time window is determined based at least in part on any one of: an SSB periodicity parameter defining a periodicity of at least one SSB when the at least one SSB is associated with a serving cell; and an SSB Measurement Timing Configuration (SMTC) defining a time window for the WD to measure the at least one SSB when the at least one SSB is associated with a neighboring cell.

Embodiment C5. The WD of any one of Embodiments C2-C4, wherein the second time window periodicity is configured one of: as an absolute time value; based on the first time window periodicity; and as an offset time value defining a time interval between the first SSB time window and the second SSB time window.

Embodiment C6. The WD of any one of Embodiments C2-C5, wherein the first SSB time window corresponds to one WD, and the second SSB time window corresponds to another WD.

Embodiment C7. The WD of any one of Embodiments C1-C6, wherein any one of each SSB of the first set of SSBs and each SSB of the second set of SSBs is transmitted using any one of one antenna port and one corresponding module, and one of the WD, the radio interface, and the processing circuitry is configured to: provide information for the network node to determine that the WD will not use any one of at least one SSB of the first set of SSBs and at least one SSB of the second set of SSBs.

Embodiment C8. The WD of any one of Embodiments C1-C7, wherein the SSB configuration includes a plurality of SSB spatial configurations defining a plurality of wireless signal beams, at least one SSB of first set of SSBs corresponding to at least a first wireless signal beam of the plurality of wireless signal beams, at least one SSB of second set of SSBs corresponding to at least a second wireless signal beam of the plurality of wireless signal beams, the at least first wireless signal beam having a first beam width, the at least second wireless signal beam having a second beam width.

Embodiment C9. The WD of Embodiment C8, wherein any one of the WD, the radio interface, and the processing circuitry is configured to: provide additional information for the network node to determine that one of the WD is located within a fraction of a coverage area and the WD is moving in a direction that indicates neighbor-cell measurements are expected; receive signaling while one of the WD is located within the fraction of the coverage area served by the network node and the WD is moving in the direction that indicates neighbor-cell measurements are expected, the at least one SSB of the second set of SSBs corresponding to the at least second wireless signal beam, the at least second wireless signal beam being selected by the network node to transmit the signaling, the second beam width being narrower than the first beam width and narrower than a width associated with the fraction of the coverage area.

Embodiment C10. The WD of any one of Embodiments C8 and C9, wherein the at least first wireless signal beam has a first angle of departure, and the at least second wireless signal beam has a second angle of departure.

Embodiment C11. The WD of any one of Embodiments C1-C10, wherein the SSB periodicity of at least one SSB of the second set of SSBs is different from one of: the first set periodicity; and the periodicity of at least another SSB of the second set of SSBs.

Embodiment C12. The WD of any one of Embodiments C1-C11, wherein the SSB configuration is received on a transmission that uses a predetermined signaling supported by the WD and not supported by other WDs.

Embodiment C13. The WD of any one of Embodiments C1-C12, wherein the SSB configuration further includes an indication indicating at least an SSB that is usable by the WD to perform measurements.

Embodiment C14. The WD of any one of Embodiments C1-C13, wherein any one of the WD, the radio interface, and the processing circuitry is configured to: receive an updated SSB configuration including at least one change to any one of the first set of SSB, the first set periodicity, the second set of SSBs, the second set periodicity, and the SSB periodicity, the received SSB configuration and the updated SSB configuration being part of a plurality of SSB configurations, each SSB configuration of the plurality of SSB configurations being one of activated and deactivated by receiving an activation signaling; receive the activation signaling; and one of activate and deactivate at least one SSB configuration of the plurality of SSB configurations based on the received activation signaling.

Embodiment D1. A method implemented in a wireless device (WD) configured to communicate with a network node, the method comprising: receiving a Synchronization Signal Block (SSB) configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity; and performing at least one measurement associated with at least one SSB of any one of the first set of SSBs and the second set of SSBs.

Embodiment D2. The method of Embodiment D1, wherein the SSB configuration includes: a first SSB time window, the first SSB time window being configured to occur periodically at a first time window periodicity and being a first time interval including at least one SSB of the first set of SSBs, the first time window periodicity being the first set periodicity; a second SSB time window, the second SSB time window being configured to occur periodically at a second time window periodicity and being a second time interval including at least one SSB of the second set of SSBs, the second time window periodicity being the second set periodicity.

Embodiment D3. The method of Embodiment D2, wherein the second time interval of the second SSB time window further includes at least one SSB of the first set of SBBs.

Embodiment D4. The method of any one of Embodiments D2 and D3, wherein any one of the first SSB time window and the second SSB time window is determined based at least in part on any one of an SSB periodicity parameter defining a periodicity of at least one SSB when the at least one SSB is associated with a serving cell; and an SSB Measurement Timing Configuration (SMTC) defining a time window for the WD to measure the at least one SSB when the at least one SSB is associated with a neighboring cell.

Embodiment D5. The method of any one of Embodiments D2-D4, wherein the second time window periodicity is configured one of as an absolute time value; based on the first time window periodicity; and as an offset time value defining a time interval between the first SSB time window and the second SSB time window.

Embodiment D6. The method of any one of Embodiments D2-D5, wherein the first SSB time window corresponds to one WD, and the second SSB time window corresponds to another WD.

Embodiment D7. The method of any one of Embodiments D1-D6, wherein any one of each SSB of the first set of SSBs and each SSB of the second set of SSBs is transmitted using any one of one antenna port and one corresponding module, and the method further comprising providing information for the network node to determine that the WD will not use any one of at least one SSB of the first set of SSBs and at least one SSB of the second set of SSBs.

Embodiment D8. The method of any one of Embodiments D1-D7, wherein the SSB configuration includes a plurality of SSB spatial configurations defining a plurality of wireless signal beams, at least one SSB of first set of SSBs corresponding to at least a first wireless signal beam of the plurality of wireless signal beams, at least one SSB of second set of SSBs corresponding to at least a second wireless signal beam of the plurality of wireless signal beams, the at least first wireless signal beam having a first beam width, the at least second wireless signal beam having a second beam width.

Embodiment D9. The method of Embodiment D8, further comprising: providing additional information for the network node to determine that one of the WD is located within a fraction of a coverage area and the WD is moving in a direction that indicates neighbor-cell measurements are expected; receiving signaling while one of the WD is located within the fraction of the coverage area served by the network node and the WD is moving in the direction that indicates neighbor-cell measurements are expected, the at least one SSB of the second set of SSBs corresponding to the at least second wireless signal beam, the at least second wireless signal beam being selected by the network node to transmit the signaling, the second beam width being narrower than the first beam width and narrower than a width associated with the fraction of the coverage area.

Embodiment D10. The method of any one of Embodiments D8 and D9, wherein the at least first wireless signal beam has a first angle of departure, and the at least second wireless signal beam has a second angle of departure.

Embodiment D11. The method of any one of Embodiments D1-D10, wherein the SSB periodicity of at least one SSB of the second set of SSBs is different from one of:

the first set periodicity; and

the periodicity of at least another SSB of the second set of SSBs.

Embodiment D12. The method of any one of Embodiments D1-D11, wherein the SSB configuration is received on a transmission that uses a predetermined signaling supported by the WD and not supported by other WDs.

Embodiment D13. The method of any one of Embodiments D1-D12, wherein the SSB configuration further includes an indication indicating at least an SSB that is usable by the WD to perform measurements.

Embodiment D14. The method of any one of Embodiments D1-D13, further comprising:

receiving an updated SSB configuration including at least one change to any one of the first set of SSB, the first set periodicity, the second set of SSBs, the second set periodicity, and the SSB periodicity, the received SSB configuration and the updated SSB configuration being part of a plurality of SSB configurations, each SSB configuration of the plurality of SSB configurations being one of activated and deactivated by receiving an activation signaling; receiving the activation signaling; and one of activating and deactivating at least one SSB configuration of the plurality of SSB configurations based on the received activation signaling.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate at least with a wireless device, WD, the network node comprising:
processing circuitry configured to:
determine a Synchronization Signal Block, SSB, configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity, any one of each SSB of the first set of SSBs and each SSB of the second set of SSBs being transmitted using any one of one antenna port and one corresponding module;
determine that the WD will not use any one of at least one SSB of the first set of SSBs and at least one SSB of the second set of SSBs; and
cause any one of the one antenna port and the one corresponding module usable to transmit the corresponding SSB to turn off; and
a radio interface in communication with the processing circuitry, the radio interface being configured to:
transmit the SSB configuration to the WD, the transmitted SSB configuration triggering the WD to perform at least one measurement associated with at least one SSB of any one of the first set of SSBs and the second set of SSBs.

2.-15. (canceled)

16. A method in a network node configured to communicate at least with a wireless device, WD, the method comprising:
determining a Synchronization Signal Block, SSB, configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity, any one of each SSB of the first set of SSBs and each SSB of the second set of SSBs being transmitted using any one of one antenna port and one corresponding module;
determining that the WD will not use any one of at least one SSB of the first set of SSBs and at least one SSB of the second set of SSBs;
turning off any one of the one antenna port and the one corresponding module usable to transmit the corresponding SSB; and
transmitting the SSB configuration to the WD, the transmitted SSB configuration triggering the WD to perform at least one measurement associated with at least one SSB of any one of the first set of SSBs and the second set of SSBs.

17. The method of claim 16, wherein determining the SSB configuration includes:
determining a first SSB time window, the first SSB time window being configured to occur periodically at a first time window periodicity and being a first time interval including at least one SSB of the first set of SSBs, the first time window periodicity being the first set periodicity; and
determining a second SSB time window, the second SSB time window being configured to occur periodically at a second time window periodicity and being a second time interval including at least one SSB of the second set of SSBs, the second time window periodicity being the second set periodicity.

18. The method of claim 17, wherein the second time interval of the second SSB time window further includes at least one SSB of the first set of SSBs.

19. The method of claim 17, wherein any one of the first SSB time window and the second SSB time window is determined based at least in part on any one of:
an SSB periodicity parameter defining a periodicity of at least one SSB when the at least one SSB is associated with a first cell; and
an SSB Measurement Timing Configuration, SMTC, defining a time window for the WD to measure the at least one SSB when the at least one SSB is associated with a second cell.

20. The method of claim 19, wherein the first cell is a serving cell, and the second cell is a neighboring cell.

21. The method of claim 17, wherein the second time window periodicity is configured one of:
as an absolute time value;
based on the first time window periodicity; and
as an offset time value defining a time interval between the first SSB time window and the second SSB time window.

22. The method of claim 17, wherein the first SSB time window corresponds to one WD, and the second SSB time window corresponds to another WD.

23. (canceled)

24. The method of claim 16, wherein the SSB configuration includes a plurality of SSB spatial configurations defining a plurality of wireless signal beams, at least one SSB of the first set of SSBs corresponding to at least a first wireless signal beam of the plurality of wireless signal beams, at least one SSB of the second set of SSBs corresponding to at least a second wireless signal beam of the plurality of wireless signal beams, the at least first wireless signal beam having a first beam width, the at least second wireless signal beam having a second beam width.

25. The method of claim 24, wherein the method further includes:
determining a fraction of a coverage area;
determining that one of the WD is located within the fraction of the coverage area and the WD is moving in a direction that indicates neighbor-cell measurements are expected;
selecting the at least one SSB of the second set of SSBs corresponding to the at least second wireless signal beam, the second beam width being narrower than the first beam width and narrower than a width associated with the determined fraction of the coverage area, the second wireless signal beam being usable to transmit signaling to the WD while one of the WD is located within the fraction of the coverage area and the WD is moving in the direction that indicates neighbor-cell measurements are expected; and
transmitting the signaling to the WD.

26.-30. (canceled)

31. A wireless device, WD, configured to communicate with a network node, the WD comprising:
a radio interface configured to:
receive a Synchronization Signal Block, SSB, configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity, any one of each SSB of the first set of SSBs and each SSB of the second set of SSBs being transmitted using any one of one antenna port and one corresponding module; and
transmit information for the network node to determine that the WD will not use any one of at least one SSB of the first set of SSBs and at least one SSB of the second set of SSBs; and
processing circuitry in communication with the radio interface, the processing circuitry being configured to:
perform at least one measurement associated with at least one SSB of any one of the first set of SSBs and the second set of SSBs.

32.-45. (canceled)

46. A method in a wireless device, WD, configured to communicate with a network node, the method comprising:
receiving a Synchronization Signal Block, SSB, configuration including a first set of SSBs to be transmitted periodically at a first set periodicity and a second set of SSBs to be transmitted periodically at a second set periodicity, each SSB of the second set of SSBs being configurable to be transmitted periodically at an SSB periodicity, any one of each SSB of the first set of SSBs and each SSB of the second set of SSBs being transmitted using any one of one antenna port and one corresponding module;
transmitting information for the network node to determine that the WD will not use any one of at least one SSB of the first set of SSBs and at least one SSB of the second set of SSBs; and
performing at least one measurement associated with at least one SSB of any one of the first set of SSBs and the second set of SSBs.

47. The method of claim 46, wherein the SSB configuration includes:
a first SSB time window, the first SSB time window being configured to occur periodically at a first time window periodicity and being a first time interval including at least one SSB of the first set of SSBs, the first time window periodicity being the first set periodicity; and
a second SSB time window, the second SSB time window being configured to occur periodically at a second time window periodicity and being a second time interval including at least one SSB of the second set of SSBs, the second time window periodicity being the second set periodicity.

48. The method of claim 47, wherein the second time interval of the second SSB time window further includes at least one SSB of the first set of SSBs.

49. The method of claim 47, wherein any one of the first SSB time window and the second SSB time window is determined based at least in part on any one of:
an SSB periodicity parameter defining a periodicity of at least one SSB when the at least one SSB is associated with a first cell; and
an SSB Measurement Timing Configuration, SMTC, defining a time window for the WD to measure the at least one SSB when the at least one SSB is associated with a second cell.

50. The method of claim 49, wherein the first cell is a serving cell, and the second cell is a neighboring cell.

51. The method of claim 47, wherein the second time window periodicity is configured one of:
as an absolute time value;
based on the first time window periodicity; and
as an offset time value defining a time interval between the first SSB time window and the second SSB time window.

52. The method of claim 47, wherein the first SSB time window corresponds to one WD, and the second SSB time window corresponds to another WD.

53. (canceled)

54. The method of claim 46, wherein the SSB configuration includes a plurality of SSB spatial configurations defining a plurality of wireless signal beams, at least one SSB of the first set of SSBs corresponding to at least a first wireless signal beam of the plurality of wireless signal beams, at least one SSB of the second set of SSBs corresponding to at least a second wireless signal beam of the plurality of wireless signal beams, the at least first wireless signal beam having a first beam width, the at least second wireless signal beam having a second beam width.

55. The method of claim 54, wherein the method further includes:
transmitting additional information for the network node to determine that one of the WD is located within a fraction of a coverage area and the WD is moving in a direction that indicates neighbor-cell measurements are expected; and
receiving signaling while one of the WD is located within the fraction of the coverage area served by the network node and the WD is moving in the direction that indicates neighbor-cell measurements are expected, the at least one SSB of the second set of SSBs corresponding to the at least second wireless signal beam, the at least second wireless signal beam being selected by the network node to transmit the signaling, the second beam width being narrower than the first beam width and narrower than a width associated with the fraction of the coverage area.

56.-60. (canceled)
